(19) United States
(12) Patent Application Publication
(10) Pub. No.: US 2013/0136612 A1
(43) Pub. Date: May 30, 2013

(54) FLUID DRIVEN TURBINE BLADE, AND TURBINE USING SAME

(71) Applicants: Rupert Stephen Tull de Salis, Ann Arbor, MI (US); Brian Joseph Zaplitny, Brighton, MI (US)

(72) Inventors: Rupert Stephen Tull de Salis, Ann Arbor, MI (US); Brian Joseph Zaplitny, Brighton, MI (US)

(73) Assignee: CLEAN GREEN ENERGY LLC, Brighton, MI (US)

(21) Appl. No.: 13/304,505

(22) Filed: Nov. 25, 2011

(51) Int. Cl. F01D 5/14; B23P 15/02

(52) U.S. Cl. 416/223 R; 29/889.7

(57) ABSTRACT

A turbine is described for deriving energy from a fluid flow. The turbine has a plurality of generally arcuate blades that are rotatable about a rotational axis transverse to the direction of fluid flow. Each blade comprises a plurality of separately formed straight sections that are straight when unstressed, and that are joined to form a blade in which at least some adjacent sections are inclined at an angle to one another.

### FIELD OF THE INVENTION

The present invention relates generally to turbines and more particularly to a fluid driven turbine for generating electrical power. Though the invention may be applied to liquid driven turbines, it is particularly intended for gas, more especially wind, turbines.

### BACKGROUND OF THE INVENTION

Wind-powered electrical generators in current use commonly employ a horizontal-axis, propeller-like, wind turbine to capture power from air flowing parallel to the rotational axis of the turbine blades. However, as the wind direction can change, such turbines need to be mounted so that they may pivot about a vertical axis in order that they may face directly into the wind.

Aspects of the present invention, on the other hand, are based on a design of turbine known as a Darrieus wind turbine. In such turbines, the blades rotate about an axis perpendicular to the wind direction, and as such can be driven by wind from any direction, without the need for reorientation.

In 1931, G. J. M. Darrieus disclosed, in U.S. Pat. No. 1,835,018, a three-bladed wind turbine mounted on a vertical rotating shaft. Since that time, the Darrieus turbine has received substantial attention as an effective means of power generation. However, the curved blades disclosed by Darrieus have proved difficult to manufacture in a cost-effective and durable manner, and have suffered failure through fatigue.

U.S. Pat. No. 4,449,053 discloses a vertical axis wind turbine of the Darrieus design having a hinged tower held by guy ropes, which may be assembled on the ground before being raised. The blades of the turbine are curved and extend between upper and lower plates supported on bearings. This turbine has the disadvantage that the curved blades are expensive and difficult to manufacture in a form giving adequate fatigue strength.

U.S. Pat. Nos. 5,375,324 and 5,499,904 disclose a similar vertical axis turbine to U.S. Pat. No. 4,449,053, in which the blades are formed from a pultruded composite material and are bent elastically from their pultruded straight shape to a curved shape without permanent deformation. The blades are constrained in a curved shape by the attached structure, and are therefore pre-stressed, creating additional strains in the material.

While such blades offer the advantage of an inexpensive manufacturing technique, they have the disadvantage that the resulting curved shape, being defined by the bending moments in the blade, is different from the ideal troposkein form, which is desirable for the purpose of minimizing further deflection arising from increasingly rapid rotation. It also has the disadvantage that it is not suitable for larger blade sections, where the required curvature creates too much strain in the blade material. A further disadvantage is that the blades are difficult and potentially dangerous to install, because the installation is necessarily carried out on site and requires a large force and a large scale deflection in each blade, before attaching it to the turbine.

Wind turbines are growing in popularity as ecologically friendly sources of energy, but their cost is still high enough to limit their installation in some applications where they might replace other, cheaper energy sources. Darrieus turbine blades, in particular, present a design challenge in respect of achieving long fatigue life at affordable cost.

Different aspects of the present invention seek to address the need for cost-effective, durable blades, which can be manufactured and installed easily, repeatably and inexpensively.

### SUMMARY OF THE INVENTION

According to an aspect of the present invention, there is provided a turbine for deriving energy from a fluid flow, having a plurality of generally arcuate blades that are rotatable about a rotational axis transverse to the direction of fluid flow, wherein each blade comprises a plurality of separately formed straight sections that are substantially straight when unstressed, and that are joined to form a blade in which at least some adjacent sections are inclined at an angle to one another.

Preferably, the leading edges of all blade sections lie in a plane parallel or substantially parallel to the rotational axis. Further preferably, the chords of all the sections are parallel to each other.

In an embodiment of the invention suited to larger wind turbines, the opposite ends of each blade are supported by a shaft arranged proximally to or on the rotational axis of the blades.

The blades in the preferred embodiment are formed by a plurality of blade sections that are joined to one another at an angle in order to achieve a linear approximation to a continuous curve, preferably a troposkein. Because the individual sections are straight when unstressed, they may conveniently be formed by extrusion of a light alloy or more preferably pultrusion of a fiber reinforced resin material.

In an embodiment of the invention, adjacent sections of each blade are joined to one another using at least one angled fitting having projections disposed at an angle to one another that are fitted within compartments, or around the ends, of the adjacent blade sections. The projections act to couple the angled fitting to the blade sections. In other embodiments, blade section are coupled to one another by having the angled projections of a fitting encase the ends of the blade sections. An end fitting is also considered which has a flange and a mating surface, for attaching an end blade section to the turbine.

To provide adequate strength, it is desirable for the angled fittings to support the straight blade sections over a distance of more than three times the smaller of the width and the height dimensions of the projections.

The angled fittings may either be molded or cast in one piece, or they may be formed by joining two separately formed halves to one another. In the latter case, each of the halves may itself be manufactured by extrusion, rolling or by using a commercially available standard prismatic material formed in any manner.

It is possible to use blade sections of different lengths always joined to one another at the same angle, or sections of the same length joined to one another at different angles depending on their position in the assembled blade. Whereas the sections of blade may readily be cut to any desired length without complicating the manufacture of the blades, using a large variety of angled fittings requires the use of many different moulds or jigs and increases the number of different component parts. It is therefore more convenient to minimize the number of types of angled fittings that are required, so the use of two or three different types of angled fittings has been found to provide an acceptable compromise.

The angled fittings may be secured to the blade sections in a variety of different ways. To improve the ability of the joints between the sections to withstand the operating stresses, the angled fitting in an embodiment of the invention is secured to the straight sections by pins inserted into holes in the straight sections and in the fitting.

In another aspect of the invention, there is disclosed a turbine blade for a turbine having a plurality of such blades that are rotatable about a rotational axis transverse to the direction of fluid flow; the blade comprises a plurality of separate blade sections that are substantially straight when unstressed, wherein the blade sections are joined to form a blade in which at least two adjacent sections are inclined at an angle to one another, and wherein the blade generally approximates an arcuate form.

Preferably, at least two adjacent blade sections are joined utilizing an angled fitting. Optionally the blade sections, and any optional fittings, are constructed to define at least one longitudinal cavity therein, to allow introducing heated fluid, such as heated air or other fluids, into the cavity. In yet another preferred embodiment, cables may be introduced to such cavity, the cable being control cable, heating cables, safety cables or any combination thereof. Preferably the blade further has two end fittings respectively disposed at the ends of the blade, for coupling the blade to the turbine.

Preferably, the end fitting have a flange with mating surface, and a coupler to attach the end fitting to the end blade section. Optionally, the end fitting defines a cavity for allowing fluid communication from the mating surface side of the flange to the interior of the blade section. The coupler may be a projection inserted into the body of blade section, or may encase the end of the blade sections.

There is also provided a method of producing a generally arcuate blade for a turbine having a plurality of such blades that are rotatable about a rotational axis transverse to the direction of fluid flow; the method comprises providing a plurality of separate blade sections that are substantially straight when unstressed, coupling at least two of blade sections to each other by coupling the respective blade section edges to an angled fitting. The fitting has two couplers disposed at an angle to each other, such that the fittings affix the two blade sections at an angle relative to each other. Optionally the method further comprises coupling two end fittings to respective end sections of the blade, wherein the end fittings comprise flanges having a mating surface, for mating the blade to the turbine.

### BRIEF DESCRIPTION OF THE DRAWINGS

The invention will now be described further, by way of example, with reference to the accompanying drawings, in which:

FIG. 1 is a side view of a Darrieus-type wind-powered generator,

FIG. 2 is a perspective view of a section of a blade of the turbine shown in FIG. 1,

FIG. 3 is a cross-section through the blade section of FIG. 2,

FIG. 4 is a side view of part of a joint showing straight blade sections joined to one another using angled fittings,

FIG. 5 is front view of an angled fitting shown in FIG. 6,

FIG. 6 is a cross-sectional view of the angled fitting taken through the central plane of FIG. 5,

FIG. 7 is a vertical cross-section through the upper end of the support shaft of the turbine and of the hub connected to the upper end of the turbine blades,

FIG. 8 is a vertical cross-section through the lower end of the support shaft of the turbine and of the hub connected to the lower ends of the turbine blades,

FIG. 9 is a perspective view of a fitting used to connect each end of a blade to one of the hubs of the support shaft,

FIG. 10 is a perspective view of an alternative fitting for connecting adjacent blade sections to one another,

FIG. 11 is a perspective view of an alternative orientation of two adjacent blade sections, and

FIG. 12 is a perspective view of the angled fitting therein, in which the angled fitting imparts both a change in angle between the longitudinal axes of the blade sections, and a change in angle in a direction that is rotational around the longitudinal axes of the blade sections, changing the angle of attack of one of the blade sections with respect to another.

### DETAILED DESCRIPTION OF AN EXEMPLARY EMBODIMENT(S)

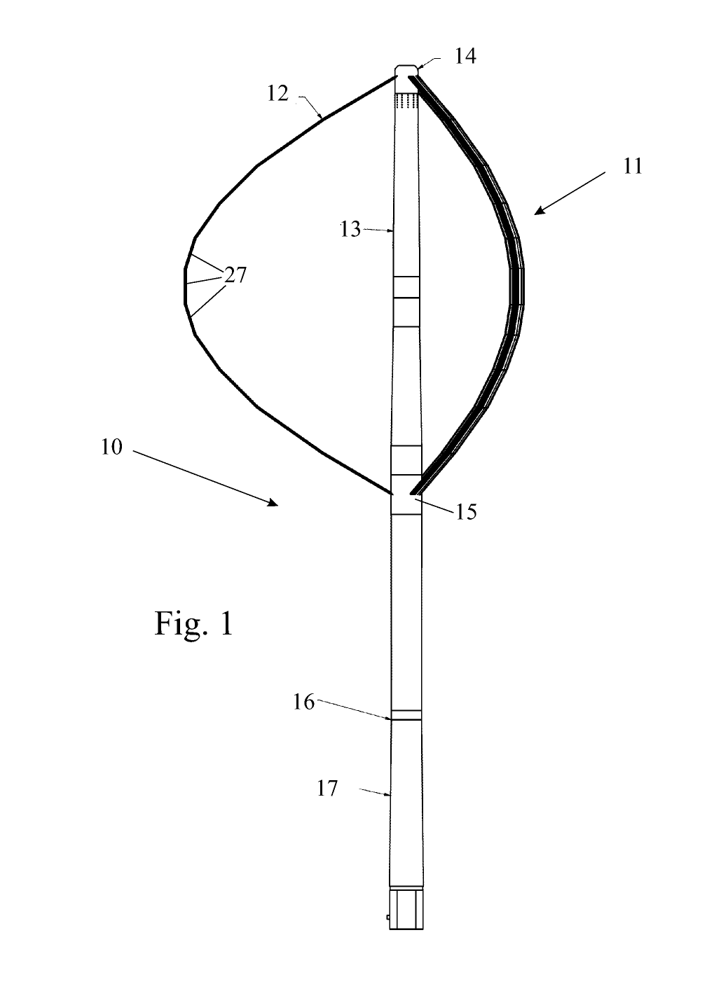

FIG. 1 shows a side view of a wind-powered generator 10 having a turbine 11 rotatable about a vertical axis. The turbine 11 has a plurality of blades 12 supported by a vertical shaft 13, and connected to the shaft 13 at two hubs 14 and 15 arranged respectively at or near the upper and lower ends of the blades 12. The vertical shaft 13 is itself rotatably supported by way of an upper bearing 16 and preferably also a lower bearing in a stationary tower 17. The stationary tower 17 can be supported by foundations in the ground or on the roof or side of a building. Preferably, the shaft 13 is tapered upwardly.

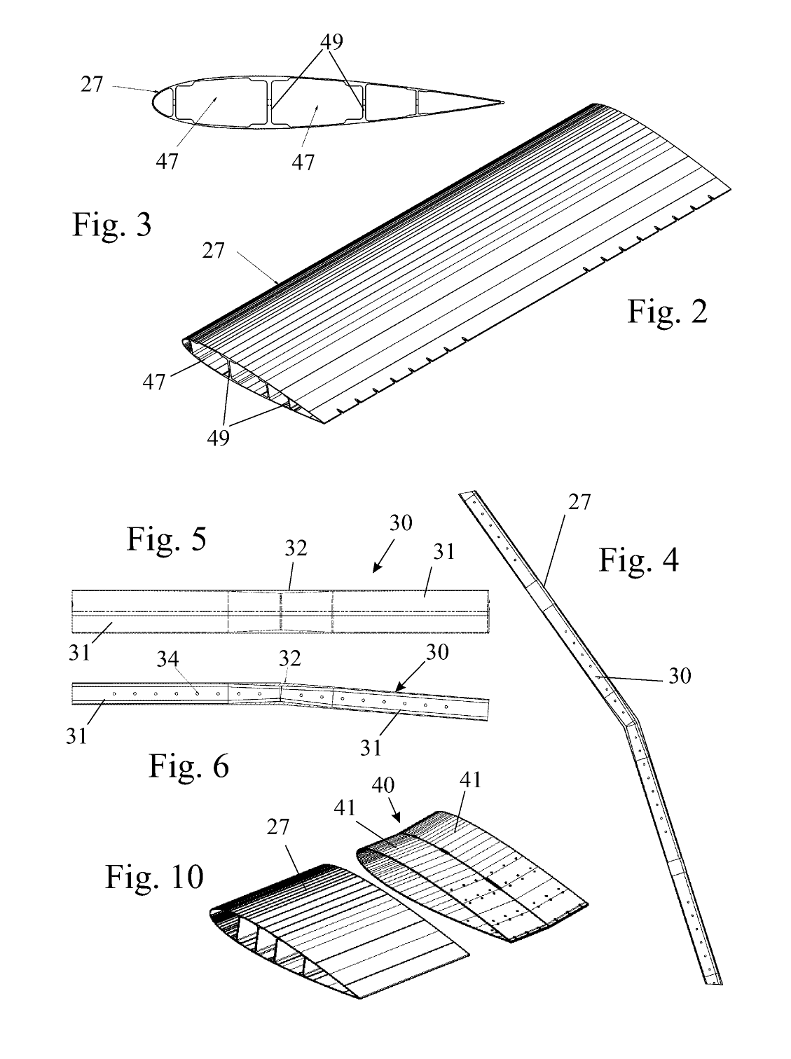

The blades 12 are formed from a plurality of linear sections 27 that are joined at an angle to one another in order, preferably to approximate to the shape of a troposkein. The individual sections 27 are straight when not stressed, one section being shown in perspective view in FIG. 2 and in cross-section in FIG. 3.

The blade section 27 in FIG. 2 is shaped as an aerofoil and has the same cross-section along its entire length. The interior of the blade section 27 is hollow and reinforced by ribs 49 dividing it into a plurality of compartments that run along the entire length of the blade section 27. As shown in FIG. 3, the two larger compartments 47 have the same shape as one another.

When rotating in the presence of sufficient wind, the blades, by virtue of their shape, capture kinetic energy from the wind and convert it into rotational torque and motion applied to the vertical shaft 13.

The individual blade sections 27 are formed preferably by pultrusion of fiber reinforced polymer or other composite material. As an alternative the blade sections may be formed by extrusion of a light metal material, such as an aluminum alloy.

The straight blade sections 27 are joined to one another in the manner shown in FIG. 4 using angled fittings 30 as shown in FIGS. 5 and 6, to lie at an angle to one another.

The angled fittings 30 are formed preferably by casting or die-casting of magnesium alloy, steel or other metallic material. If formed by molding or casting, it is possible to increase the wall thickness of the fitting at its central region 32, as shown by the shaded portion in FIG. 6 and the dotted line in FIG. 5. The angled fitting is also formed with holes 34 to receive fixing pins for securing the fittings to the blade sections 27.

Alternatively, the angled fittings 30 may be formed of two initially separate halves that are joined to one another, for example by welding, gluing, bonding, fastening, and the like.

The cross-sectional shape of each fitting 30 corresponds to the shape of the two compartments 47 in the blade sections 27. Because in this embodiment the two compartments have the same shape, the same fitting can be used in both compartments.

To join two blade sections to one another, the two projections 31 of a fitting 30 are inserted one into each of the compartments 47 of the two adjacent blade sections and the blade sections 27 are pushed together. To prevent their separation, pins are then inserted transversely into the holes 34 through holes drilled into the leading edges of the blade sections 27. A jig is used to assist in drilling the holes in the blade sections 27 to line up with the pre-drilled holes 34 in the angled fittings. It will be clear to the skilled in the art that other securing methods may be used.

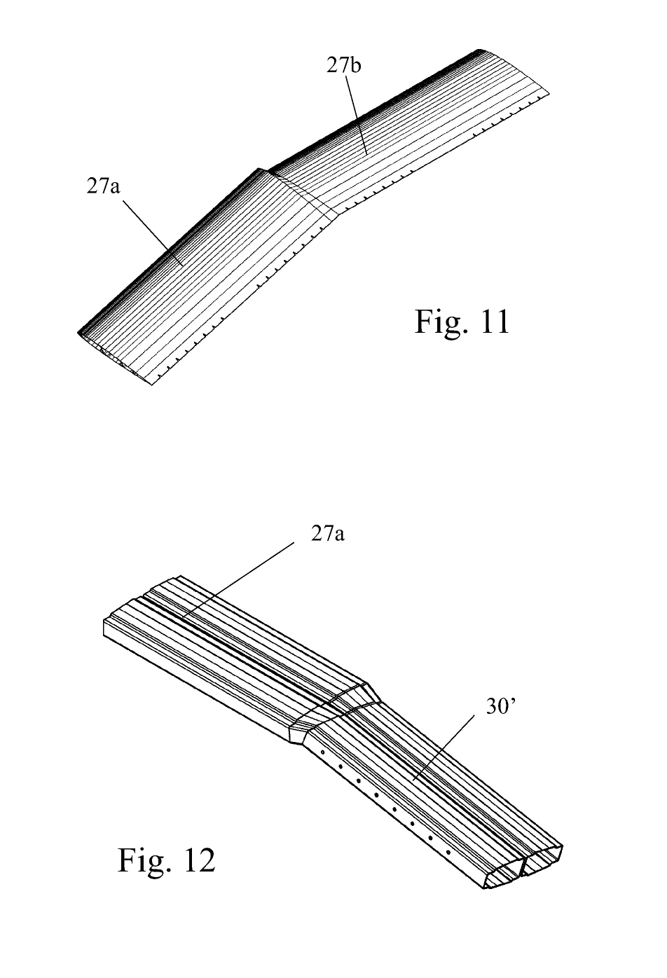

While the above describes a fitting with two angled projections acting as coupler, the fitting may also be implemented with other couplers, such as by having couplers which encase the ends of the blade sections as shown in FIG. 10, in which the fitting 40 has two inclined sleeve-like projections 41 to encase the ends of the adjacent blade sections.

When all the blade sections 27 are joined to one another, the leading edges of all the sections lie in the same general plane but the blade sections are inclined relative to one another when viewed in a direction normal to the latter plane, as may be seen on FIG. 1.

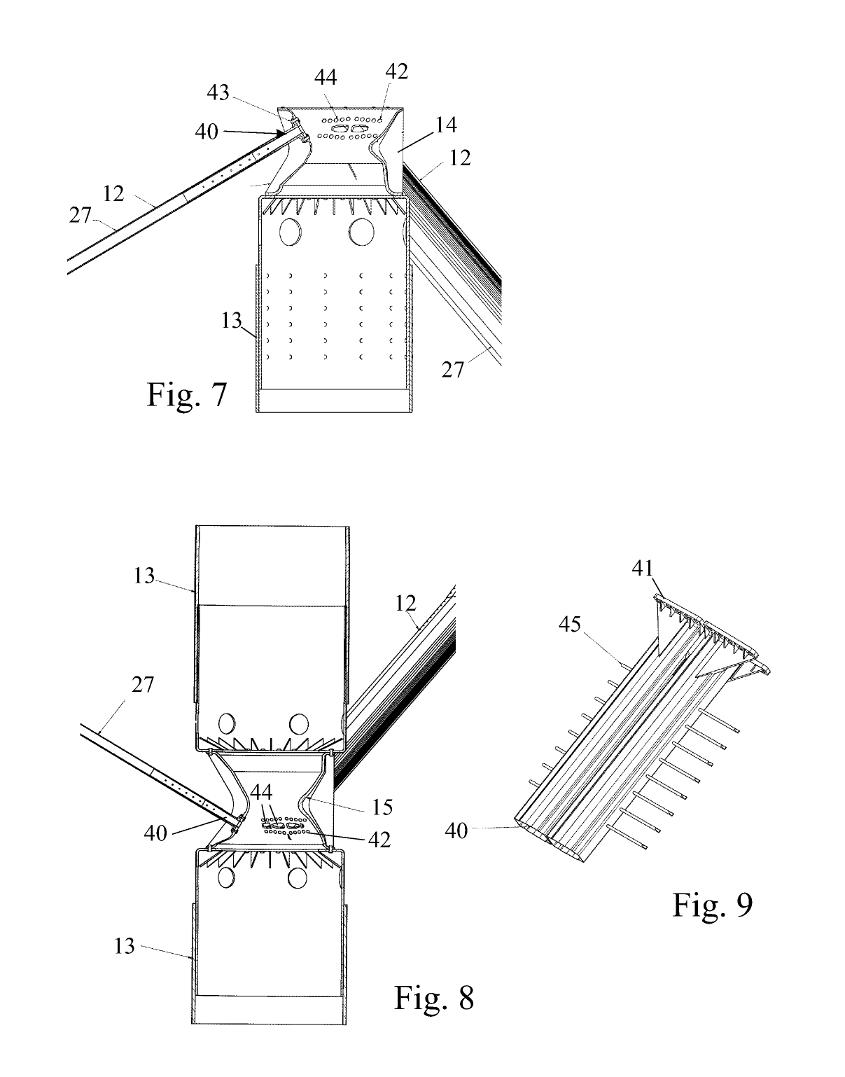

The preferred manner in which the ends of the blades are attached to the support shaft 13 is shown in FIGS. 7 to 9. Hubs 14 and 15 are secured to the support shaft 13. Preferably, support shaft 13 is tapered to reduce the stress. The hubs are shaped to provide connection surfaces inclined at the desired angle in which there are formed a plurality of holes 42 and 44. The holes 42 are used to anchor an end fitting 40, shown in perspective view in FIG. 9, that is connected to the upper or lower end of a blade 12. The holes 44, on the other hand, are provided to allow control cables, heating cables, or safety cables to be passed along the length of the blades or to allow a heated gas flow through the interior of the blades 12.

The end fitting 40 has a mounting plate 41 with holes that line up with the holes 42 in the hubs 14 and 15. Suitable fasteners 43 inserted into these aligned holes are used to secure the mounting plate 41 to a hub. The fasteners may be bolts and nuts or rivets. More preferably, the fasteners may be lock-bolts of the rivet type as supplied by Alcoa Fastening Systems Huck, of Telford, in the United Kingdom. Such lock-bolts having the advantage of an automatic installation method, eliminating certain operator errors encountered with bolted connections, such as the failure to apply the correct torque. However the skilled in the art will readily recognize a plurality of other methods of attaching the fittings to the hubs.

Two projections from the mounting plate 41 extend, one each, into the compartments 42 of the end blade sections and secure the hubs 14 and 15 to the blades 12, preferably by the same method as is used to connect the blade sections 27 to one another. FIG. 9 shows the pins 45 that are used to anchor the end fitting 40 in a blade section 27.

To provide sufficient strength at the junction between blade sections 27 and at the junction between the blades and the hubs, the fittings 30 and the end fittings 40 extend into the blade sections over a distance of more than three times the narrowest cross-section dimension of the compartment 47.

To allow for modification to the aerodynamic performance of the turbine, adjacent blade sections may be arranged with different pitch angles. FIG. 11 is a perspective view of an alternative orientation of two adjacent blade sections 27a and 27b imparting a difference in pitch angle. FIG. 12 is a perspective view of a modified angled fitting 30′ which imparts both a change in angle between the longitudinal axes of the blade sections, and a change in angle in a direction that is rotational around the longitudinal axes of the blade sections, changing the angle of attack of one of the blade sections with respect to another.

The embodiment of the invention described above provides the following advantages, particularly when compared with horizontal-axis wind-turbine blades of which the cross section varies along their length, and vertical-axis wind-turbines having blades that are formed with continuous curvature:
The blade straight sections may be manufactured by the cost-effective, repeatable and geometrically precise method of pultrusion, or by extrusion, in which shape, fiber density and orientation, and therefore strength and aerodynamic performance, are highly repeatable.
The blade straight sections may be generated with one, or relatively few different cross sectional shapes, requiring reduced design and development effort compared to a blade with varying cross-section along its length.
The angled fittings may be manufactured using the cost-effective, repeatable and geometrically precise methods of die-casting or extrusion.
The stiffness of the blades is sufficient to ensure that the resonant frequencies of the blades exceed the exciting frequency of wind loading on the rotating blades.
The blade straight sections and angled joints and joining methods may be tested for yield strength, fatigue strength, weight, stiffness and aerodynamic performance by testing a small number of parts, which for analytical purposes may accurately represent all the other similar parts of the blade. In particular, it is not necessary to test a complete blade, this being a very expensive and time consuming process for a large scale blade. The invention offers a more efficient and more reliable method of ensuring blade durability and performance, when compared with the task of developing and testing a blade of varying cross section along its length, and or which has been constructed with significant input of manual labor and therefore is prone to variability of strength.
The yield strength, fatigue strength, weight, stiffness and aerodynamic performance of the blades may be analyzed with less effort, by taking advantage of the repeating elements in the blade and joint designs.
It is easy to provide hollow cavities throughout the length of the blade, ensuring that heavy structurally strong material is concentrated efficiently at the outer edge of the blade section, and providing a passageway for electrical wiring, safety cables or other devices.
Assembly of the blades may be carried out using pins in a repeatable, easy operation that does not rely upon adhesives, is robust against operator error, and is easy to check for completeness.
Surprisingly, the aesthetic appearance of an arcuate blade formed according to this invention from straight sections, is reminiscent of stealth technology in aircraft and pleasing. It does not suggest inelegance or poor functionality to the observer.
Although the arcuate shape of the blade must necessarily deviate from a shape optimized for purposes of stress reduction, the extent of this deviation can be reduced by incorporating multiple joints up to whatever number is selected.
Any refinement or improvement to the aerodynamic section of the blade may be incorporated relatively cheaply, by simply modifying the pultrusion die used to form the straight sections.
The design allows easy deployment of differing airfoils at differing areas of the blade.
The design provides for a variation in pitch angle between adjacent blade sections, for the purpose of adjusting the aerodynamic performance, appearance and or noise characteristics of the turbine.
Surprisingly, the overall effect of the above advantages is sufficient to render the Darrieus turbine cost-effective and durable so that it becomes an attractive alternative to the more conventional horizontal axis wind turbines. It is then possible to take advantage of the inherent advantages of the Darrieus vertical axis wind turbine, including omni directionality (no need to orient the blades to the wind), attractive appearance, low noise and a lower incidence of bird strikes.

The skilled in the art will recognize that the turbine does not have to operate in wind, but may be operated by any fluid, such as water, gas, and the like. Furthermore, the turbine may be arranged in any desired orientation.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

1. A turbine for deriving energy from a fluid flow, the turbine having a plurality of generally arcuate blades that are rotatable about a rotational axis transverse to the direction of fluid flow, wherein at least one of the blades comprises a plurality of separate blade sections that are substantially straight when unstressed, the blade sections being joined to form a blade in which at least two adjacent sections are inclined at an angle to one another.

2. The fluid turbine of claim 1 wherein the opposite ends of each blade are supported by a shaft arranged on the rotational axis of the blades.

3. The fluid turbine of claim 1 wherein the straight blade sections are formed by pultrusion.

4. The fluid turbine of claim 1 wherein the straight blade sections are formed by extrusion.

5. The fluid turbine of claim 1 further comprising a plurality of angled fittings for joining adjacent blade sections, the fittings having coupler projections disposed at an angle to one another, the projections dimensioned to be received within longitudinally extending compartments in the blade sections.

6. The fluid turbine of claim 5 wherein the angled fitting extends to support the straight blade sections over a distance of more than three times the smaller of the height and width dimensions of the projections.

7. The fluid turbine of claim 5 wherein the projections of the angled fitting are formed integrally with one another.

8. The fluid turbine of claim 5, wherein the angled fitting is formed of two separately formed halves that are joined to one another.

9. The fluid turbine of claim 1 further comprising a plurality of fittings for joining two adjacent blade sections, each fitting having couplers disposed at an angle to one another that encase the ends of the blade sections.

10. The fluid turbine of claim 9 wherein the angled fitting extends to support the blade sections over a distance of more than three times the largest dimension of the cross section of the blade section.

11. The fluid turbine of claim 9 wherein the couplers of the angled fitting are formed integrally with one another.

12. The fluid turbine of claim 9, wherein the angled fitting is formed of two separately formed halves that are permanently joined to one another.

13. The fluid turbine of claim 5 in which the angled fitting is secured to the straight sections by pins inserted into holes in the straight sections and the fitting.

14. The fluid turbine of claim 1, further comprising at least one end fitting fitted to an end section of at least one blade, wherein the end fitting having a flange with mating surface, and a coupler to attach the end fitting to the end blade section, the fitting further defining a cavity for allowing fluid communication from the mating surface side of the flange to the interior of the blade section.

15. The fluid turbine of claim 14, wherein heated fluid is introduced into the blade or a section thereof via the cavity.

16. The fluid turbine of claim 16, wherein said fluid is heated gas.

17. The fluid turbine of claim 1, further comprising at least one end fitting fitted to an end section of at least one blade, wherein the end fitting having a flange and a coupler to attach the end fitting to the end blade section, the fitting further constructed to allow communication of at least one cable from the flange to the interior of the blade section.

18. A turbine blade for a turbine having a plurality of such blades that are rotatable about a rotational axis transverse to the direction of fluid flow, the blade comprising:
a plurality of separate blade sections that are substantially straight when unstressed;
wherein the blade sections being joined to form a blade in which at least two adjacent sections are inclined at an angle to one another, and wherein the blade generally approximates an arcuate form.

19. The blade as claimed in claim 18, wherein the at least two adjacent blade sections are joined utilizing an angled fitting.

20. The blade of claim 18 wherein the blade sections are constructed to define at least one longitudinal cavity therein, for introduced heated fluid into the cavity.

21. A method of producing a generally arcuate blade for a turbine having a plurality of such blades that are rotatable about a rotational axis transverse to the direction of fluid flow, the method comprising:
providing a plurality of separate blade sections that are substantially straight when unstressed;
Coupling at least two of blade sections to each other by coupling the respective blade section edges to an angled fitting, the fitting having two couplers disposed at an angle to each other, such that the fittings affix the two blade sections at an angle relative to each other.

22. A method as claimed in claim 21, further comprising coupling two end fittings to respective end sections of the blade, wherein the end fittings comprise flanges having a mating surface, for mating the blade to the turbine.
